(19) United States
(12) Patent Application Publication
(10) Pub. No.: US 2009/0218017 A1
(43) Pub. Date: Sep. 3, 2009

(54) Tire, a Mold for Vulcanizing the Tire, a Method of Fabricating the Mold, and a Mold Matrix

(75) Inventors: Cedric Delbet, Chamalieres (FR); Olivier Lauwers, Yronde et Buron (FR); Gerard Alegre, Clermont-Ferrand (FR); Jose Merino-Lopez, Riom (FR); Jean-Claude Desvignes, Gerzat (FR)

Correspondence Address: COHEN, PONTANI, LIEBERMAN & PAVANE LLP, 551 FIFTH AVENUE, SUITE 1210, NEW YORK, NY, 10176, US

(73) Assignee: Michelin Recherche et Technique S.A., Granges-Paccot (CH)

(21) Appl. No.: 12/341,994

(22) Filed: Dec. 22, 2008

(30) Foreign Application Priority Data
Dec. 21, 2007 (FR) 07/60285

(51) Int. Cl. B60C 11/117; B29D 30/06

(52) U.S. Cl. 152/209.1; 425/28.1; 156/110.1

(57) ABSTRACT

A tire includes a tread in which there is provided a molded channel. The molded channel is interrupted by at least one furrow of the tread and extends along a curved path. The path of the molded channel is preferably substantially parallel to an outside surface of the tread in a radial section plane of the tire.

### RELATED APPLICATION

This application claims the priority of French patent application Ser. No. 07/60285 filed Dec. 21, 2007, the entire content of which is hereby incorporated by reference.

### FIELD OF THE INVENTION

The present invention relates to the technical field of tires.

Below, the term axis is used with respect to a tire to designate its axis of revolution. This axis defines an axial direction of the mold, as considered when the tire is in the mold.

### BACKGROUND OF THE INVENTION

A tire generally has a tread forming a body of revolution about the axis of the tire. The tread includes in particular a tread design that provides the tire with good grip.

Wear of the tread leads to the tread design wearing away and thus to a drop in the grip performance of the tire.

This applies in particular to a tire for a heavy good type vehicle, and it is known to embed channels in the rubber that forms the tread, which channels serve in particular to limit the loss of grip of the tire when the tread wears. Wear of the rubber constituting the tread leads to the channels showing on the surface of the tread. These flush channels form grooves that can replace, at least in part, the initial tread design that has worn away.

In the state of the art, and in particular from document WO 03/029031, a tire is known that includes molded channels in the tread. Each channel extends parallel to the axis of rotation of the tire.

Nevertheless, when the tread wears away, not all of the channels become flush simultaneously over the entire tread, which means that grip is lost in a manner that is non-uniform.

### OBJECT AND SUMMARY OF THE INVENTION

An object of the invention is to provide a tire in which grip is relatively uniform after the tread has worn.

To this end, one aspect of the invention is directed to a tire including a tread having at least one molded channel formed therein, the molded channel being interrupted by at least one furrow of the tread, extending along a curved path and presenting at least two curvatures about two radii that are not coplanar.

Such a tire enables uniform grip to be obtained after the tread has worn. Since the channel follows a curved path, arrangements are made to ensure that the curve is substantially parallel to the curved crown of the tire such that the channel can be caused to show on simultaneously over the entire tread as it wears away. Thus, loss of grip is limited in a manner that is relatively uniform over the entire tread.

According to optional characteristics of the tire of the invention:
The path of the molded channel is substantially parallel to an outside surface of the tread in a radial section plane of the tire. As explained above, such a channel is particularly effective for a tire that is subjected to wear that is substantially uniform over the entire tread.
The tread includes a plurality of channels that are spaced apart radially and circumferentially.

In an embodiment of the tire of the invention, the molded channel extends axially over the entire width of the tread.

In another embodiment of the tire of the invention, the molded channel extends axially over a fraction of the width of the tread.

To understand the description below, the term “liner” is used to designate the part that presents the final mold shape that is to impart its shape to the tire. The liner thus has a shape that is the negative of the shape of the final tire. The term “matrix” is used to designate the part that serves to mold the mold liner. The matrix thus has a shape that is the positive of the tire shape and the negative of the liner shape.

Another aspect of the invention is directed to a mold for vulcanizing a tire, comprising:
a molding member for molding a molded channel in a tire tread; and
a liner carrying a molding surface for molding a portion of the tire tread, the liner including at least one fillet for molding a furrow in the tread; the fillet including at least one guide channel for guiding the molding member, the guide channel extending through the fillet.

Each guide channel enables the molding member to be guided, in particular enables it to follow a curved path.

According to optional characteristics of the mold of the invention:
The molding member is substantially filamentary in shape and, after being inserted into the guide channel, it extends substantially parallel to a surface of the liner for molding an outside surface of the tread of the tire.
The fillet includes at least two radially spaced-apart guide channels.
The molding member is substantially filamentary in shape and, after being inserted in the guide channel, presents at least two curvatures about two radii that are not coplanar.

Advantageously, at least one end of the guide channel is defined by a flared inner edge, preferably without any sharp portions.

Inserting the molding member in the guide channel is thus made easier. Since the inside edge is flared, the molding member is guided to the inside of the guide channel.

Optionally, the guide channel is formed by an liner arranged in the fillet.

The use of an insert enables the guide channel to be calibrated accurately relative to the molding member. Such calibration would be more difficult to obtain if the guide channel were formed directly in the fillets, e.g. by drilling. Thus, during vulcanization of the tire, the accurate calibration serves to prevent rubber from passing between the guide channel and the molding member, which would lead to an unsightly rubber sleeve being formed. By suitably selecting the material for the insert, it is possible to reduce the wear caused by the molding member moving on each baking cycle, thereby correspondingly delaying the appearance of clearance that could lead to rubber sleeves being formed.

At this stage, it should be observed that it is entirely possible to make a mold having guide channels made directly in the fillets or in the blades of the mold. Nevertheless, as mentioned above, it should be observed that the guide channels would wear very quickly because of the nature of the materials generally employed for fabricating the mold liner.

According to an optional characteristic of the mold of the invention, the molding member for molding the channel is coated in an non-stick coating.

The non-stick coating serves to limit the axial forces exerted on the mold while unmolding the vulcanized tire. The molding member needs to be moved axially so as to allow the vulcanized tire to be unmolded. The non-stick coating serves to reduce friction between the channel molded in the rubber and the molding member being moved therealong.

The non-stick coating also serves to make the outer section of the molding member more uniform. The bare molding member generally presents a section that is irregular, such that during molding of the tire, rubber might infiltrate between the guide channel and the bare molding member, thereby forming an unsightly rubber sleeve. Sleeve formation can be avoided by virtue of the coating.

Preferably, the molding member for molding the channel is coated in a coating comprising a compound of the polyetheretherketone type.

In addition, a coating that comprises a polyetheretherketone type compound presents properties of being inert at high temperatures, thereby avoiding deterioration thereof and avoiding pollution of the tire rubber while the tire is being vulcanized.

According to another optional characteristic of the mold of the invention, for a liner including at least first and second axially spaced-apart fillets, the molding member extends through first and second successive guide channels that are arranged respectively in the first and second fillets common to the molding member.

Advantageously, considering the path followed by the molding member through the first and second guide channels, the outlet of the first guide channel points so as to direct the molding member towards the inlet of the second guide channel.

Thus, putting the molding member into place in the guide channels is made simpler. While the molding member is being inserted into the first and second guide channels, the molding member can penetrate into the second guide channel without it being necessary for the user to intervene to guide the member between the first and second guide channels.

Optionally, the length of the path between the first and second successive guide channels is no more than 40 millimeters (mm).

This characteristic makes it possible to prevent the molding member from sagging under the effect of rubber pressure while the tire is being molded. In addition, by reducing the distance between the first and second successive guide channels, the curvature that is imparted to the molding member can be increased.

Another aspect of the invention is directed to a method of fabricating a so-called final liner having a molding surface for molding a portion of a tire tread, the final liner including at least one molding fillet for molding a furrow in the tread, the method being of the type in which the final liner is molded on a so-called final matrix, the final matrix including at least one so-called final insert for forming a housing in the fillet of the final liner for receiving a member forming a guide channel for guiding a molding member for molding a channel in the tread.

According to optional characteristics of the method of the invention:
The final insert is formed by the member forming the guide channel.
The final matrix is made of a material that is inert relative to the molten material of the final liner.
The final matrix is made of a material comprising sand and/or plaster. The use of a material comprising sand or plaster makes it easy to unmold the final liner. Such a material is easily fragmented and, furthermore, is inexpensive and suitable for recycling.

Optionally, prior to molding the final liner on the final matrix, the following steps are performed:
molding an intermediate liner of shape substantially similar to that of the final liner on an intermediate matrix of shape substantially similar to the final matrix;
ensuring the intermediate matrix includes at least one intermediate insert for forming a housing in a fillet of the intermediate liner for receiving the final liner; and
molding the final matrix on the intermediate liner.

Advantageously, the intermediate liner is molded out of a material having shape memory, preferably an elastomer material, e.g. comprising silicone.

The shape memory material enables the intermediate liner to be cut easily. Furthermore, the intermediate liner as molded in this way can be reused.

According to an optional characteristic of the method of the invention, the intermediate matrix comprises:
at least one removable block comprising two mutually separable portions, each including a housing for positioning the intermediate insert; and
a base including at least one housing for positioning the removable block.

Since the block is removable, the intermediate liner can be separated from the base. Furthermore, since the removable block comprises two mutually separable portions, it can be separated from the intermediate insert molded in the fillet of the intermediate liner without it being necessary to fragment the intermediate matrix, so it is therefore reusable.

In addition, the housing for the intermediate insert, enabling the intermediate insert to be positioned axially in the fillet of the intermediate matrix, may be formed accurately in each of the separable portions, independently of fabricating the base.

Advantageously, the intermediate matrix is made of a plastics material, preferably by molding or by machining.

By way of example, the plastics material makes the base easy to machine accurately, in particular concerning the housing for positioning the removable block. In addition, the plastics material is generally compatible with the material of the intermediate liner.

According to an optional characteristic of the method of the invention, at least one substantially transverse cut is made in a fillet of the intermediate liner, preferably a skew cut, said cut terminating in a housing for an intermediate insert so as to enable the final insert to be withdrawn by being moved through the cut.

Cutting the intermediate fillet and using shape memory material makes it possible to separate the intermediate liner from the final matrix without fragmenting the intermediate liner, where that would run the risk of damaging the final matrix.

Advantageously, after molding the intermediate liner on the intermediate matrix, and before molding the final matrix on the intermediate liner, the intermediate insert is replaced by the final insert.

After the intermediate insert has been replaced by the final insert, the skew cut in the fillet of the intermediate matrix makes it possible to reposition the cut portions of the fillet of the intermediate liner accurately relative to each other.

By replacing the intermediate insert with the final insert, the method of fabricating the mold is simplified. It is possible to use intermediate inserts that are of a standard length while using final inserts that present different lengths that are appropriate depending on their locations within the fillet of the final matrix.

Optionally, the intermediate insert and/or the final insert includes a collar for holding it axially relative to the fillet of the intermediate and/or final liner.

The final insert generally presents an axial dimension that is sufficient to project on either side from the fillet through which it passes. While molding the tire, the collar enables the final insert to be held in a position that is accurate relative to the fillet so as to avoid untimely axial shifting of the final insert relative to the fillet, since that could give rise to an unsightly draft being formed in the molded rubber on one side of the fillet, and to an exaggerated undercut being formed on the other side of the fillet.

Preferably, the intermediate insert and the final insert both have respective collars. Since the intermediate insert is positioned axially in the fillet of the intermediate liner by means of the positioning housing formed in the moving block, the collar serves to position the final insert identically in the fillet of the final liner.

Another aspect of the invention is directed to a matrix for molding a liner having at least one molding surface for molding a portion of a tread of a tired, the matrix comprising:
at least one removable block comprising two mutually separable portions each including a housing for positioning an insert for forming, in the fillet of the liner, a housing for a member for forming a guide channel for a molding member for molding a molded channel in the tread; and
a base including at least one housing for positioning the removable block.

### DETAILED DESCRIPTION OF THE DRAWINGS

The invention can be better understood on reading the following description given purely by way of non-limiting example and made with reference to the accompanying drawings, in which:

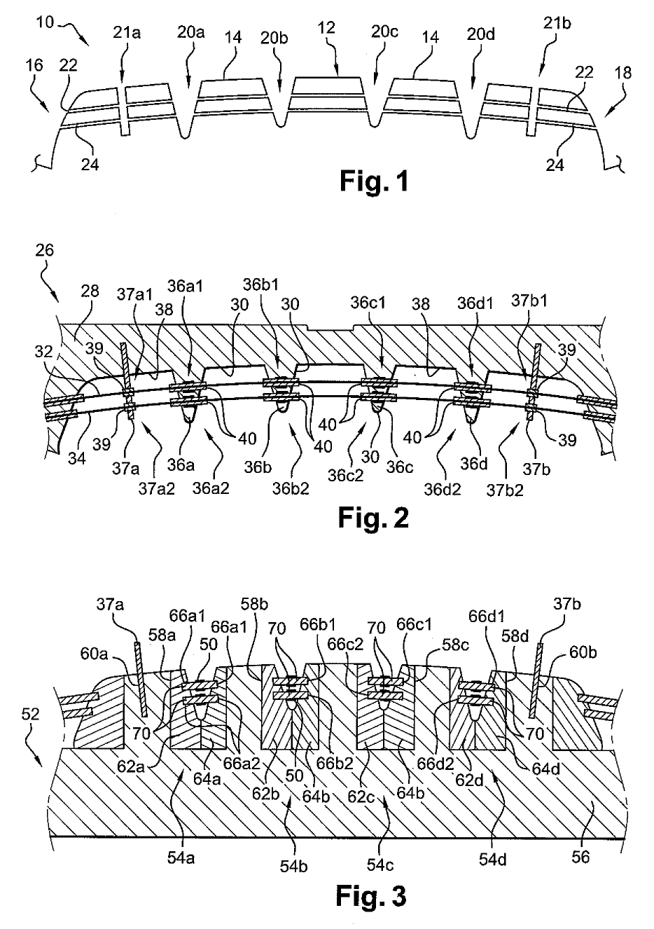

FIG. 1 is a section view in a radial plane of a tire in a first embodiment of the invention;

FIG. 2 is a section view in a radial plane of a mold liner including molding members enabling the FIG. 1 tire to be fabricated;

FIG. 3 is a section view in a radial plane showing an intermediate matrix of the FIG. 2 liner, comprising a base and removable blocks;

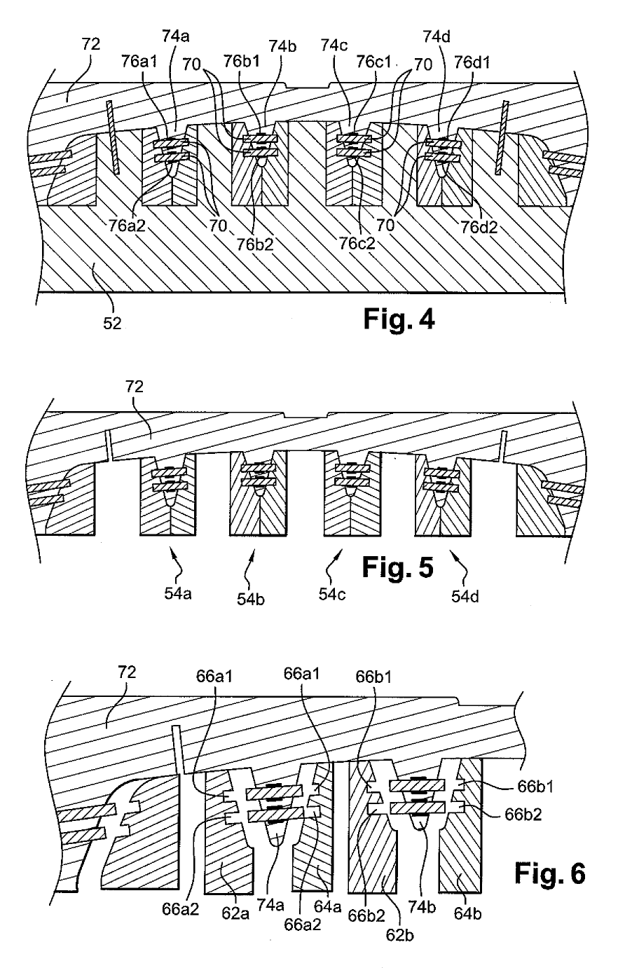

FIG. 4 is a section view in a radial plane showing the FIG. 3 intermediate matrix with an intermediate liner molded thereon;

FIG. 5 is a section view in a radial plane of the FIG. 4 intermediate liner together with removable blocks after the base has been withdrawn;

FIG. 6 is an enlarged view of FIG. 5 showing removable blocks of the intermediate liner in a separation position relative to the intermediate liner;

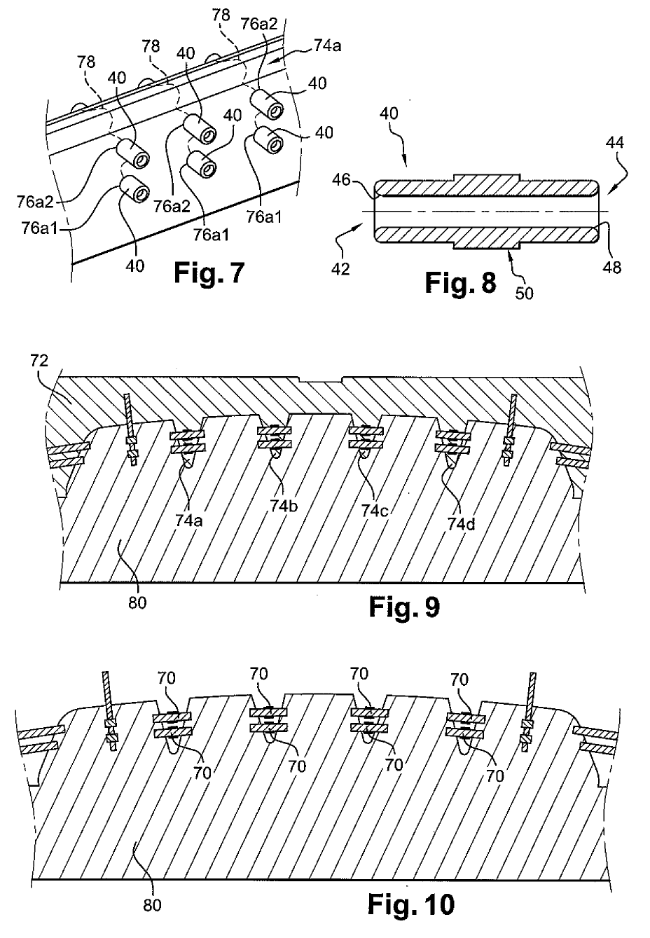

FIG. 7 is a perspective view of a fillet of the intermediate liner;

FIG. 8 is an axial section view of a final insert forming a guide channel for the molding member;

FIG. 9 is a section view in a radial plane of the intermediate liner of FIGS. 4 to 6, on which a final matrix is molded;

FIG. 10 is a section view in a radial plane of the final matrix after the intermediate liner has been withdrawn;

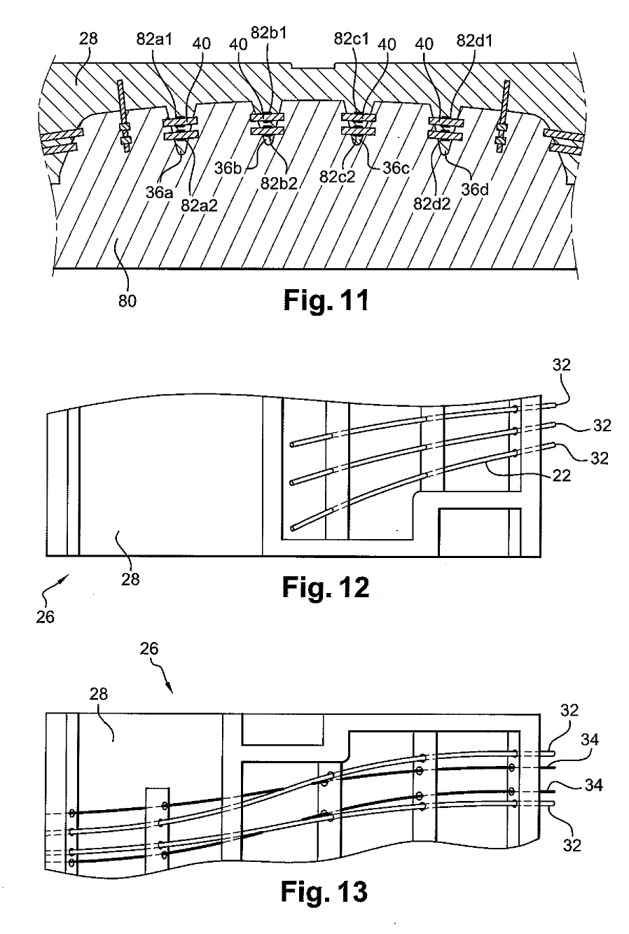

FIG. 11 is a section view in a radial plane of the final matrix overmolded with a final liner;

FIG. 12 is a plan view of a mold liner in a second embodiment of the invention, showing the molding members in the guide channels; and

FIG. 13 is a plan view of a mold liner in a third embodiment of the invention, showing the molding members in the guide channels.

### DETAILED DESCRIPTION OF THE DRAWINGS

FIG. 1 shows a tire constituting a first embodiment of the invention and given overall reference 10.

The tire 10 includes a tread 12. The tread 12 includes an outside surface 14 that is to come into contact with the road, and two shoulders 16 and 18. In addition, the tread 12 includes furrows 20a-d and incisions 21a-b formed in the rubber of the tread 12. The furrows 20a-d and the incisions 21a-b are axially spaced apart from one another and they are distributed over the entire axial dimension of the tread 12.

Two channels 22 and 24 are formed in the tread 12. The two channels 22 and 24 are regularly spaced apart. In addition, each channel 22 or 24 extends over the entire axial dimension of the tread 12, from the shoulder 16 to the shoulder 18, and it is interrupted by the furrows 20a-b and the incisions 21a-b. For the needs of the present description, there are two channels in the radial direction. Nevertheless, it is possible without departing from the teaching of the invention to provide one channel or more channels that are radially spaced apart. Similarly, the channels may also be spaced apart in a circumferentially-determined distribution.

Furthermore, in the radial plane of the tire shown in FIG. 1, each channel 22, 24 extends along a curved path substantially parallel to the outside surface 14. FIG. 2 shows a mold 26 suitable for fabricating the tire 10 of FIG. 1.

The mold 26 has a liner 28 carrying a molding surface 30 for molding a portion of the tread 12 of the tire 10. The mold 26 also has molding members 32 and 34 for molding the channels 22 and 24 respectively.

The liner 28 has a plurality of radially spaced apart fillets 36a-d that are for molding the furrows 20a-d. The liner 28 also has two blades 37a-b for unmolding the incisions 21a-b. The surface 30 includes a molding surface 38 for molding the outside surface 14 of the tire 10.

The fillets 36a-b and blades 37a-b include respectively, firstly successive channels 36a1, 36b1, 36c1, 36d1, 37a1, and 37b1 for guiding the member 32, and secondly successive channels 36a2, 36b2, 36c2, 36d2, 37a2, and 37b2 for guiding the member 34. Each guide channel extends through a fillet or a blade. Guide channels passing through the same fillet or the same blade are spaced apart radially. In addition, the length of the path between two successive channels is no more than 40 mm.

Each guide channel 37a1-a2, 37b1-b2 is formed by a cylindrical ring 39. Each guide channel 36a1-a2, 36b1-b2, 36c1-c2, and 36d1-d2 is formed by an insert 40, referred to as a final insert, and shown in greater detail in FIG. 8. Each insert 40 has two ends 42 and 44 defined by respective inside edges 46 and 48. The section of the insert may be circular, as suggested in FIG. 8, or of arbitrary shape depending on the shape it is desired to impart to the channels. Each inside edge 46, 48 is flared and has no sharp portions. Each insert 40 also includes a collar 50 for holding it axially relative to the corresponding fillet 36a-d.

Each molding member 32 or 34 is substantially filamentary in shape and is generally in the form of a flexible needle. The member 32 is common to the successive channels 36a1, 36b1, 36c1, and 36d1 and it extends substantially parallel to the surface 30 through said channels 36a1, 36b1, 36c1, and 36d1. Similarly, the member 34 is common to the channels 36a2, 36b2, 36c2, and 36d2, and it extends substantially parallel to the surface 30 through the channels 36a2, 36b2, 36c2, and 36d2.

With reference to the path of the member 32 through the channels 36a1 to 36d1, the outlets of the channels 36a1, 36b1, 36c1 point in such directions as to direct the member 32 towards the inlets of the channels 36b1, 36c1, 36d1 respectively. The inlets and outlets of the channels 36a2 to 36d2 are arranged, mutatis mutandis, like the inlets and outlets of the channels 36a1 to 36d1.

In addition, each molding member 32 and 34 is provided with an non-stick coating so as to facilitate extraction of said molding member from the tread after the tire has itself been extracted. Specifically, a coating comprising a compound of the polyetheretherketone type has been found to be effective.

The mold 26 can be fabricated by implementing a method of the invention, the main steps of which are described below with reference to FIGS. 3 to 10.

FIGS. 3 and 4 show an intermediate matrix 52. This intermediate matrix 52 comprises removable blocks 54a-d and a base 56. The base 56 includes housings 58a-d for positioning the removable blocks 54a-d. The base 56 also has housings 60a-d for positioning the blades 37a-b, respectively.

Each removable block 54a-d comprises two portions 62a-d and 64a-d that are mutually separable. The block 54a has two housings 66a1 and 66a2 for positioning two intermediate inserts 70. Specifically, each portion 62a and 64a includes part of each of the housings 66a1, 66a2. Each block 54b-d includes two housings with references that can be deduced, mutatis mutandis, from the references of the block 54a. In the example shown, all of the intermediate inserts 70 are identical.

Like the final insert, each intermediate insert 70 includes an axial retention collar 50. Each intermediate insert 70 presents an outside shape similar to that to the final insert 40. However, an intermediate insert 70 is solid whereas a final insert 40 is tubular.

The intermediate matrix 52 comprising the base 56 and the removable blocks 54a-d is made of a soft plastics material by molding, or preferably by machining.

In addition, as shown in FIG. 4, an intermediate liner 72 is molded on the intermediate matrix 52. The intermediate liner 72 is of a shape substantially similar to that of the final liner 28 shown in FIG. 2.

In the example shown, the intermediate liner 72 is molded of a material having shape memory. Specifically, the material commonly used is of the elastomer type and may comprise silicone.

Each intermediate insert 70 forms a respective housing 76a1-a2, 76b1-b2, 76c1-c2, or 76d1-d2 respectively in each of the filets 74a-d of the intermediate liner 72 for the purpose of receiving a corresponding final insert 40.

Thereafter, as shown in FIG. 5, the intermediate liner 72 is withdrawn from the base 56.

Then, as shown in FIG. 6, the two portions 62a-d and 64a-d are separated so as to release each intermediate insert 70 from its corresponding housing 66.

Thereafter, substantially transverse skew cuts 78 are made in each fillet 74a-d of the intermediate liner 72.

After the above step, each intermediate insert 70 is replaced by the corresponding final insert 40.

Thus, as shown in FIG. 7, where there can be seen only the intermediate fillet 74a, it can be seen that the cut 78 leads to the housings 76a1 and 76a2 for the final insert 40 in such a manner as to enable these inserts 40 to be withdrawn by moving through the cut 78.

In a variant, the intermediate insert 40 could be replaced by the final insert 70 after cutting the fillets 74a-d.

Thereafter, the blades 37a-b provided with the guide rings 39 in the intermediate liner 72 are replaced.

Thereafter, as shown in FIG. 9, the final matrix 80 is molded on the intermediate liner 72. In order to avoid the material of the final matrix 80 penetrating into the guide channels formed by the insert 40, the guide channels are plugged temporarily. The final matrix 80 includes the final insert 40.

With reference to FIG. 10, the final matrix 80 is of a shape that is substantially similar to the intermediate matrix 52. The final matrix 80 is made of a material that is inert relative to the molten material of the final liner 28. This material preferably comprises sand and/or plaster.

Thereafter, the intermediate liner 72 of the final matrix 80 is withdrawn as shown in FIG. 10. The cuts 78 enable the fillets 74a-d of the intermediate liner 72 to be separated from the inserts 40. The intermediate liner 72 is then ready for subsequent use in molding a new final matrix. It is then appropriate to reintroduce inserts 40 into the housings 76a1-a2, 76b1-b2, 76c1-c2, and 76d1-d2.

Finally, as shown in FIG. 11, the final liner 28 is molded on the final matrix 80. The final liner 28 is molded out of a metal, and in this example out of aluminum.

Each insert 40 forms, in each fillet 36a-d of the final liner 28, a housing 82a1-a2, 82b1-b2, 82c1-c2, and 82d1-d2, for a member forming the corresponding guide channels 36a1-a2, 36b1-b2, 36c1-c2 or 36d1-d2. Specifically, the members forming the guide channels 36a1-a2, 36b1-b2, 36c1-c2, and 36d1-d2, are the final inserts 40.

Finally, the final matrix 80 is fragmented so as to release the final liner 28, and the inserts 40 are opened.

FIG. 12 shows a liner 28 of a mold 26 in a second embodiment of the invention. In FIG. 12, elements that are analogous to elements in the above-described figures are designated by references that are identical.

For reasons of clarity, only some of the guide channels 36a-d are shown.

Unlike the mold of the first embodiment, each molding member 32 presents at least two curvatures with two radii that are not coplanar. Thus, each member 32 extends along a path that is curved when projected onto a radial plane, and along a path that is curved when projected flat onto the liner 28. In addition, each member 32 extends over a fraction only of the axial size of the liner 28.

In order to facilitate inserting molding members 32 into the mold 26, each molding member 32 is preshaped.

FIG. 13 shows a liner 28 of a mold 26 in a third embodiment of the invention. In FIG. 13, elements analogous to elements of the above-described figures are designated that are identical.

Unlike the first embodiment, each molding member 32, 34 presents two curvatures with respective radii that are not coplanar. In addition, when projected flat onto the liner 28, each member 32 and 34 presents a point of inflection.

From the above, it is entirely possible to cause the flexible molding member to follow a path that presents one or more variations in curvature depending on the positions of the blocks of rubber placed on the tread. This advantage expands the options available when designing the tire by reducing the limits imposed by methods of the prior art.

What is claimed is:

1. A tire including a tread having at least one molded channel formed therein, the molded channel being interrupted by at least one furrow of the tread, extending along a curved path and presenting at least two curvatures about two radii that are not coplanar.

2. A mold for vulcanizing a tire, comprising:
a molding member for molding a molded channel in a tire tread; and
a liner carrying a molding surface for molding a portion of the tire tread, the liner including at least one fillet for molding a furrow in the tread, wherein the fillet includes at least one guide channel for guiding the molding member, the guide channel extending through the fillet.

3. The mold according to claim 2, wherein the molding member is substantially filamentary in shape and, after being inserted into the guide channel, it extends substantially parallel to a surface of the liner for molding an outside surface of the tread of the tire.

4. The mold according to claim 2, wherein the molding member is substantially filamentary in shape and, after being inserted in the guide channel, presents at least two curvatures about two radii that are not coplanar.

5. The mold according to claim 2, wherein at least one end of the guide channel is defined by a flared inner edge, preferably without any sharp portions.

6. The mold according to claim 2, wherein the guide channel is formed by an liner arranged in the fillet.

7. The mold according to claim 2, wherein the liner includes at least first and second axially spaced-apart fillets, the molding member extends through first and second successive guide channels that are arranged respectively in the first and second fillets common to the molding member.

8. A method of fabricating a so called final liner having a molding surface for molding a portion of a tire tread, the final liner including at least one molding fillet for molding a furrow in the tread, wherein the method comprises molding the final liner on a so-called final matrix, the final matrix including at least one so-called final insert for forming a housing in the fillet of the final liner for receiving a member forming a guide channel for guiding a molding member for molding a channel in the tread.

9. The method according to claim 8, wherein the final insert is formed by the member forming the guide channel.

10. The method according to claim 8, wherein prior to molding the final liner on the final matrix, the following steps are performed:
molding an intermediate liner of shape substantially similar to that of the final liner on an intermediate matrix of shape substantially similar to the final matrix;
ensuring the intermediate matrix includes at least one intermediate insert for forming a housing in a fillet of the intermediate liner for receiving the final liner; and
molding the final matrix on the intermediate liner.

11. The method according to claim 10, wherein the intermediate matrix comprises:
at least one removable block comprising two mutually separable portions, each including a housing for positioning the intermediate insert; and
a base including at least one housing for positioning the removable block.

12. The method according to claim 10, wherein at least one substantially transverse cut is made in a fillet of the intermediate liner, preferably a skew cut, said cut terminating in a housing for an intermediate insert so as to enable the final insert to be withdrawn by being moved through the cut.

13. The method according to claim 10, wherein:
after molding the intermediate liner on the intermediate matrix; and
before molding the final matrix on the intermediate liner, the intermediate insert is replaced by the final insert.

14. A matrix for molding a liner having at least one molding surface for molding a portion of a tread of a tired, the matrix comprising:
at least one removable block comprising two mutually separable portions each including a housing for positioning an insert for forming, in the fillet of the liner, a housing for a member for forming a guide channel for a molding member for molding a molded channel in the tread; and
a base including at least one housing for positioning the removable block.
